(19) United States
(12) Patent Application Publication
(10) Pub. No.: US 2009/0033591 A1
(43) Pub. Date: Feb. 5, 2009

(54) LIQUID CRYSTAL DISPLAY

(75) Inventor: Hiroki Ikeya, Kanagawa (JP)

Correspondence Address: DARBY & DARBY P.C., P.O. BOX 770, Church Street Station, New York, NY, 10008-0770, US

(73) Assignee: Komatsu Ltd, Minato-ku, Tokyo (JP)

(21) Appl. No.: 11/917,645

(22) PCT Filed: May 23, 2006
(86) PCT No.: PCT/JP2006/310232

§ 371 Date: Dec. 14, 2007

(30) Foreign Application Priority Data
Jun. 24, 2005 (JP) 2005-185333

(51) Int. Cl. G09G 3/28

(52) U.S. Cl. 345/60

(57) ABSTRACT

A liquid crystal display which is installed in a work vehicle provided by the present invention includes a luminance adjusting section which can manually adjust luminance of a backlight in a liquid crystal panel, setting means which sets a luminance adjustable range by means of the luminance adjusting section, and measuring means which measures total operating time of the work vehicle, wherein the setting means has a first storage section which stores a predetermined luminance adjusting range for each operating time of the backlight therein, uses the total operating time measured by the measuring means as the substantial operating time, reads the luminance adjusting range corresponding to the operating time from the first storage section, and sets the read adjusting range as the luminance adjustable range in the luminance adjusting section so that an operator can arbitrarily adjust the luminance of the backlight.

### TECHNICAL FIELD

The present invention relates to a liquid crystal display which is installed in a working vehicle such as a construction machine. More specifically, the invention relates to a liquid crystal display which can adjust luminance of a backlight in the liquid crystal display within a suitable adjusting range according to total operating time of a working vehicle.

### BACKGROUND ART

At the present, liquid crystal displays are used in various fields such as display of measuring gauges in automobiles and construction machines, and displays of notebook personal computers and televisions. Liquid crystal displays have, for example, a transmitting type liquid crystal panel and a backlight. According to such liquid crystal displays, light of the backlight irradiated from a rear surface of a liquid crystal panel is controlled so as to be transmitted or shielded by a liquid crystal panel, so that a video picture can be projected to the liquid crystal panel. For this reason, the luminance of the backlight is influenced by tone and contrast of the screen in the liquid crystal panel. When the backlight is allowed to emit light by the luminance of not less than a certain level, so that a video picture can be clearly displayed on the liquid crystal panel.

In such liquid crystal displays, a cold cathode fluorescent tube having a cold cathode is generally used as a light source of the backlight. The cold cathode fluorescent tube is constituted so that a negative pole and a positive pole are disposed on both ends of a glass tube to which a fluorescent layer is applied, and inert gases such as a suitable amount of hydrargyrum and argon are enclosed in the glass tube. In such a cold cathode fluorescent tube, secondary electrons are discharged from the negative pole by applying a predetermined voltage between electrodes. The secondary electrodes collide against the hydrargyrum in the glass tube, and the hydrargyrum which is excited by this collision emits an ultra violet ray. The fluorescent layer of the glass tube is excited by the ultra violet ray and visible light is generated to thereby allow the cold cathode fluorescent tube to emit light.

On the other hand, when a cold cathode fluorescent tube is used with a constant voltage being applied thereto, as the used hours become longer, the luminance is gradually reduced, namely, a so-called aged deterioration in the luminance occurs. When the luminance of a cold cathode fluorescent tube to be a backlight is reduced in liquid crystal displays, a screen of a liquid crystal panel becomes dark, and contrast is reduced so that an image quality is deteriorated.

In general, the aged deterioration in the luminance in cold cathode fluorescent tube is caused because ultra violet rays emitted at the time of light emission of the cold cathode fluorescent tube deteriorates the fluorescent layer applied to the glass tube. For this reason, for example, when the liquid crystal display is used while setting the luminance of the backlight to a high value, a deterioration in the fluorescent layer due to the ultra violet rays makes progress quickly, and thus a lifetime of the backlight tends to become short. On the contrary, when the backlight is used with its luminance being set to a lower value, the deterioration in the fluorescent layer due to ultra violet rays can be delayed, and thus the lifetime of the backlight can be prolonged.

The lifetime of the backlight generally means the time of the following state. That is, at the starting of use of the liquid crystal display, an applied voltage to the backlight at the time when the backlight emits brightest light is determined as a predetermined voltage, and the luminance of the backlight emitting light at this time is standard luminance (100%). When that liquid crystal display is used in the case where the predetermined voltage and the standard luminance are predetermined, only luminance which is 50% of the standard luminance is obtained or the backlight is turned off even if the voltage whose strength is the same as that of the predetermined voltage is applied to the backlight. This time is the lifetime of the backlight.

Therefore, a manufacturer recommends that the luminance of the backlight is set to a lower level at which a sufficient function as the light source can be obtained, namely, about 50 to 60% of the standard luminance, and the liquid crystal screen is displayed in order to prolong the lifetime of the backlight even if only slightly. However, actually some operators or users, who use the liquid crystal displays, set the luminance of the backlight to a higher value than an initial use stage (for example, 90 to 100% of the standard luminance) beyond necessity in order to display the liquid crystal screen more clearly, and thus the lifetime of the backlight is shortened.

Patent Document 1 (Japanese Patent Application Laid-Open No. 6-167695), therefore, discloses a contrast correcting device of a liquid crystal display as means for preventing an operator from setting the luminance of the backlight to a high value beyond necessity and prevents deterioration in contrast and image quality even if aged deterioration in the luminance of the backlight occurs. The contrast correcting device disclosed in Patent Document 1 utilizes a property such that the luminance of the backlight changes when a voltage to be applied to the backlight is varied, and has means for changing a voltage to be applied from a power source circuit to the backlight according to elapse of the used hours of the backlight.

More specifically, the contrast correcting device in Patent Document 1 controls a voltage to be applied to the backlight at the time of starting of the use of the liquid crystal display, and turns on the display at the luminance for making the backlight sufficiently function as the light source, namely, the luminance which is 50 to 60% of the standard luminance. At the same time, used lapse time of the backlight is started to be measured by measuring means. As the used lapse time of the backlight becomes longer, the applied voltage to the backlight is gradually increased in order to correct a deterioration in the luminance.

As a result, the aged deterioration of the backlight occurs, the luminance of the backlight can be always maintained at a certain constant value which is about 50 to 60% of the standard luminance. Therefore, it is possible to prevent a deterioration in image quality of the liquid crystal screen due to the aged deterioration of the backlight. Further, since the luminance of the backlight is always maintained at the constant value, an operator can be prevented from setting excessive high luminance of the backlight. For this reason, the lifetime of the backlight can be prolonged.

### Patent Document 1: Japanese Patent Application Laid-Open No. 6-167695

### DISCLOSURE OF THE INVENTION

### Problem to be Solved by the Invention

In general, viewability of liquid crystal displays greatly varies according to their used time zones (daytime or nighttime), service spaces and difference among operators. Further, since the luminance of a cold cathode fluorescent tube as the light source of a backlight changes also due to steam pressure of hydrargyrum enclosed in a glass tube, the luminance greatly depends environmental temperature at which the liquid crystal displays are used. That is, for example in the cases where the same liquid crystal displays are used at the environmental temperature of 20° C. and at the environmental temperature of −20° C., the luminance of the backlight greatly changes, and thus the image qualities of the liquid crystal screens are completely different.

For this reason, in the liquid crystal displays, particularly the liquid crystal displays to be installed in a construction machine whose service environment is strict, the luminance of a backlight and the contrast of a screen are desirably adjusted according to operators who perform the operation and the use environment of the liquid crystal displays. However, when a liquid crystal display is constituted so that an operator can freely adjust the luminance of a backlight, the operator sets excessively high luminance of the backlight, and thus the lifetime of the backlight is shortened.

On the other hand, when the contrast correcting device in Patent Document 1 is used, the lifetime of the backlight can be prolonged. However, in the contrast correcting device in Patent Document 1, the luminance of the backlight is always maintained at a predetermined constant value. For this reason, an operator cannot arbitrarily adjust the luminance of the backlight according to a use environment and the like.

The present invention is devised in order to solve such conventional problems, and its concrete object is to provide a liquid crystal display to be installed in a work vehicle such as a construction machine, which enables an operator to arbitrarily adjust the luminance of a backlight according to a used environment and the like, prevents the operator from setting excessively high luminance of the backlight so as to prolong lifetime of the backlight, and can prevent deterioration in contrast and an image quality due to aged deterioration of the backlight.

### Means for Solving the Problems

In order to achieve the above object, a liquid crystal display of the present invention to be installed in a work vehicle, is mainly characterized by including: a luminance adjusting section which can manually adjust luminance of a backlight in a liquid crystal panel; setting means for setting a luminance adjustable range by means of the luminance adjusting section; and measuring means for measuring total operating time to date for which the work vehicle actually operates. In the liquid crystal display, the setting mean includes a first storage section which stores predetermined luminance adjusting range for each operating time of the backlight, uses the total operating time measured by the measuring means as substantial operating time so as to read a luminance adjusting range corresponding to the operating time from the first storage section, and sets the read adjusting range as the luminance adjustable range in the luminance adjusting section.

The liquid crystal display of the present invention is mainly characterized by including: temperature measuring means for measuring environmental temperature in which the liquid crystal display is to be used, wherein the setting means includes a second storage section which stores predetermined correcting coefficients for each environmental temperature therein, and reads the total operating time measured by the measuring means and the environmental temperature measured by the temperature measuring means, reads a correcting coefficient corresponding to the read environmental temperature from the second storage section, multiplies the read total operation time by the read correcting coefficient so as to calculate first virtual total operating time, and uses the calculated first virtual total operating time as the substantial operating time to date in the backlight.

In this case, the liquid crystal display is mainly characterized in that the setting means determines whether or not the environmental temperature read from the temperature measuring means is less than predetermined temperature, and when the read environmental temperature is not less than the predetermined temperature, the setting means does not calculate the first virtual total operating time and uses the total operating time measured by the measuring means as the substantial operating time to date in the backlight, and when the read environmental temperature is less than the predetermined temperature, the setting means calculates the first virtual total operating time based on the environmental temperature, and uses the calculated first virtual total operating time as the substantial operating time to date in the backlight

Further, the liquid crystal display of the present invention is mainly characterized by including: temperature measuring means for measuring environmental temperature in which the liquid crystal display is to be used; calculating means for calculating corrected operating time obtained by correcting elapsed unit operating time based on the environmental temperature read from the temperature measuring means every time when the total operating time read from the measuring means exceeds the unit operating time after the starting of the operation of the work vehicle; and a third storage section which sequentially adds and stores the corrected operating time calculated by the calculating means so as to store second virtual total operating time. In the liquid crystal display, the calculating means includes a second storage section which stores predetermined correcting coefficients for each of the environmental temperature therein, and calculates an average value or a minimum value of the environmental temperatures read from the temperature measuring means within the unit operating time every time when the total operating time read from the measuring means exceeds the unit operating time after the staring of the operation of the work vehicle, reads a correcting coefficient corresponding to the calculated average value or the minimum value of the environmental temperatures from the second storage section, multiplies the value of the unit operating time by the read correcting coefficient so as to calculate corrected operating time by correcting the unit operating time, and sequentially adds and stores the calculated corrected operating time in the third storage section every time when the corrected operating time is calculated so as to store second virtual total operating time in the third storage section. The setting means reads the second virtual total operating time from the third storage section, and uses the read second virtual total operating time as the substantial operating time to date in the backlight.

### EFFECTS OF THE INVENTION

In the liquid crystal display of the present invention, the setting means has the first storage section where a luminance adjusting is predetermined for each operating time, and uses the total operating time of the work vehicle measured by the measuring means as the substantial operating time so as to read a luminance adjusting range corresponding to the operating time from the first storage section. The read luminance adjusting range can be set as the luminance adjustable range in the luminance adjusting section. That is, according to the present invention, the luminance adjustable range in the luminance adjusting section can be suitably set based on the substantial operation time of the backlight to be an indicator showing a luminance deteriorated state in the backlight.

Therefore, an operator of the work vehicle can arbitrarily adjust the luminance of the backlight according to a use state and the like of the liquid crystal display within the luminance adjusting range set suitably by the setting means. Further, the luminance adjusting range in the luminance adjusting section is suitably set according to the substantial operation time to date in the backlight. For this reason, even if the operator can arbitrarily adjust the luminance of the backlight, excessively high luminance of the backlight is prevented from being set, and the lifetime of the backlight can be prolonged.

In the present invention, as the substantial operating time of the backlight becomes longer, the range is widened so that the upper limit of the luminance adjustable range in the luminance adjusting section becomes large, and the adjusting range can be set so that a high voltage can be applied to the backlight. As a result, even if the aged deterioration of the backlight occurs, the higher voltage can be applied to the back light according to the aged deterioration. For this reason, as the operating time of the backlight becomes longer, the higher voltage is applied so that the deterioration in the luminance can be prevented, resulting in prevention of deterioration in contrast and image quality due to the aged deterioration of the backlight.

In the liquid crystal display of the present invention, the setting means calculates the first virtual operating time based on the total operating time of the work vehicle and the environmental temperature of the liquid crystal display, and can use the calculated first virtual operating time as the current substantial operating time in the backlight. As a result, even if the environmental temperature of the liquid crystal display, for example, greatly changes, the setting means can set the suitable luminance adjusting range in the luminance adjusting section stably according to the environmental temperature. For this reason, the operator manually operates the luminance adjusting section so as to be capable of arbitrarily adjusting the luminance of the backlight within the adjusting range set according to the environmental temperature.

In this case, when the environmental temperature measured by the temperature measuring means is not less than predetermined temperature, the total operating time measured by the measuring means can be used as the current substantial operating time in the backlight without calculating the first virtual operating time. Therefore, the setting means reads the adjusting range corresponding to the total operating time from the first storage section so as to set it in the luminance adjusting section.

On the other hand, when the measured environmental temperature is less than the predetermined temperature, the setting means calculates the first virtual total operating time based on the environmental temperature. The adjusting range corresponding to the calculated first virtual total operating time may be read from the first storage section so as to be set in the luminance adjusting section. When a determination is made whether or not the first virtual operating time is calculated according to the environmental temperature, the work in the setting means is made to be efficient, so that the luminance adjusting range can be stably set in the luminance adjusting section.

In the liquid crystal display of the present invention, the calculating means can calculate the corrected operating time obtained by correcting the unit operating time of the work vehicle based on the environmental temperature. The calculated corrected operating time can be sequentially added and stored in the third storage section. Consequently, the calculating means can store the second virtual total operating time corresponding to the change in the environmental temperature for unit operating time in the third storage section.

Further, the setting means may read the second virtual total operating time from the third storage section to use the read second virtual operating time as the current substantial operating time in the backlight. As a result, the setting means can suitably set the adjusting range corresponding to the change in the environmental temperature for unit operating time as the luminance adjustable range in the luminance adjusting section.

### BRIEF DESCRIPTION OF THE DRAWINGS

FIG. 1 is a block diagram illustrating a constitution of a liquid crystal display according to a first embodiment.

FIG. 2(a) is a diagram illustrating one example of a measuring gauge display screen to be displayed on a liquid crystal panel, FIG. 2(b) is a diagram illustrating one example of an image quality adjusting screen to be displayed on the liquid crystal panel, and FIG. 2(c) is a diagram illustrating another example of the image quality adjusting screen to be displayed on the liquid crystal panel.

FIG. 3(a) is a diagram illustrating a luminance adjusting range for each operating time of a backlight stored in a first storage section, and FIG. 3(b) is a diagram illustrating correcting coefficients for each environmental temperature stored in a second storage section according to a second embodiment.

FIG. 4 is a flow chart illustrating setting of the luminance adjusting range in the liquid crystal display according to the first embodiment.

FIG. 5 is a block diagram illustrating a constitution of a liquid crystal display according to the second embodiment.

FIG. 6 is a flowchart illustrating setting of the luminance adjusting range in the liquid crystal display according to the second embodiment.

FIG. 7 is a block diagram illustrating a constitution of a liquid crystal display according to a third embodiment.

FIG. 8 is a diagram illustrating correcting coefficients for each environmental temperature stored in a second storage section according to the third embodiment.

FIG. 9 is a flowchart illustrating setting of the luminance adjusting range in the liquid crystal display according to the third embodiment.

FIG. 10 is a flow chart illustrating calculation of second virtual total operating time in the liquid crystal display according to the third embodiment.

### EXPLANATION OF LETTERS OR NUMERALS

1: liquid crystal display
2: monitor section
3: controller section
4: sensor section
5: liquid crystal panel
6: backlight
7: image quality adjusting section
8: brightness adjusting section
9: contrast adjusting section
10: luminance adjusting section
11: measuring gauge display screen
12: fuel indicator
13: water temperature gauge
14: oil temperature gauge
15: time display section
16, 16′: image quality adjusting screen
17: brightness display section
18: contrast display section
19: luminance display section
20: setting means
21: measuring means
22: first storage section
23: second storage section
24: environmental temperature sensor
25: water temperature sensor
26: oil temperature sensor
27: fluid level sensor
28: liquid crystal display
29: controller section
30: setting means
31: liquid crystal display
32: controller section
33: setting means
34: calculating means
35: third storage section
36: second storage section

### BEST MODE FOR CARRYING OUT THE INVENTION

A liquid crystal display according to the present invention will be described in detail below with reference to the drawings by giving examples. In the following examples, a liquid crystal display which is installed in a hydraulic shovel as one of work vehicles is exemplified. However, the present invention is not limited to this, and can be applied to a liquid crystal display to be installed in various work vehicles such as a construction machine and an automobile. In the following description, a luminance adjusting range of a luminance adjusting section in the liquid crystal display and total operating time of a hydraulic shovel are described by giving concrete numerical values, but the present invention is not limited to them. The present invention can be suitably modified according to use environments of the liquid crystal display.

### FIRST EMBODIMENT

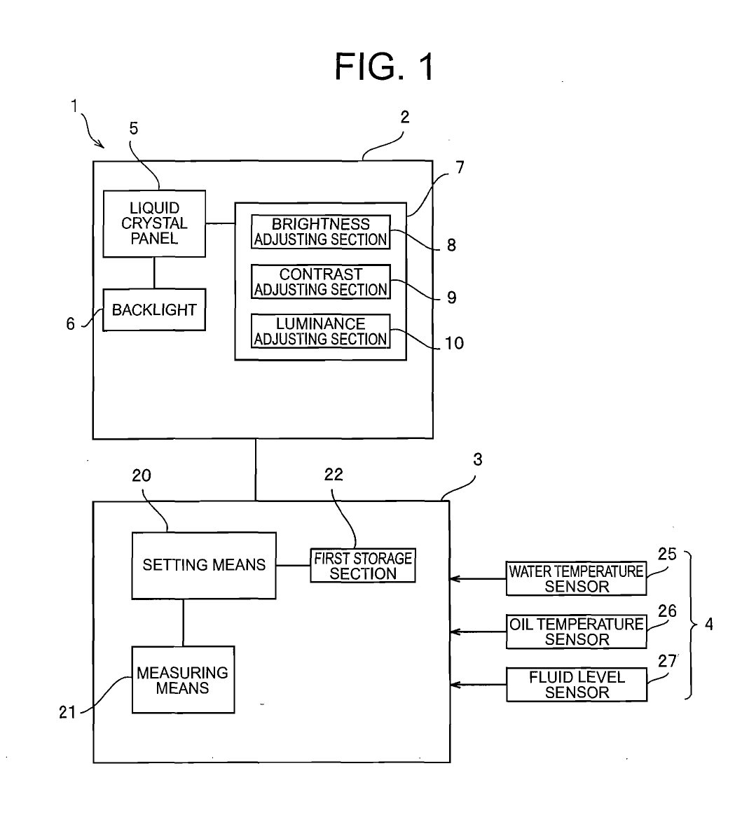

FIG. 1 is a block diagram illustrating a constitution of a liquid crystal display according to a first embodiment.

The liquid crystal display 1 shown in FIG. 1 is composed of a monitor section 2 which enables an operator to visually recognize a liquid crystal screen and perform various operations, a controller section 3 which controls the monitor section 2, and a sensor section 4 which detects an operating state of a hydraulic shovel.

The monitor section 2 has a transmission-type liquid crystal panel 5 which is disposed at a driver's seat of the hydraulic shovel to display an image, a backlight 6 which is disposed on a rear surface of the liquid crystal panel 5 to illuminate, and an image quality adjusting section 7 which adjusts an image quality of a screen projected on the liquid crystal panel 5. A brightness adjusting section 8, a contrast adjusting section 9 and a luminance adjusting section 10 are provided as the image quality adjusting section 7. The respective adjusting sections 8 to 10 can be constituted so that when a touch panel function is provided to the liquid crystal pane 5, an operator is enabled to perform a manual operation on a screen of the liquid crystal panel 5.

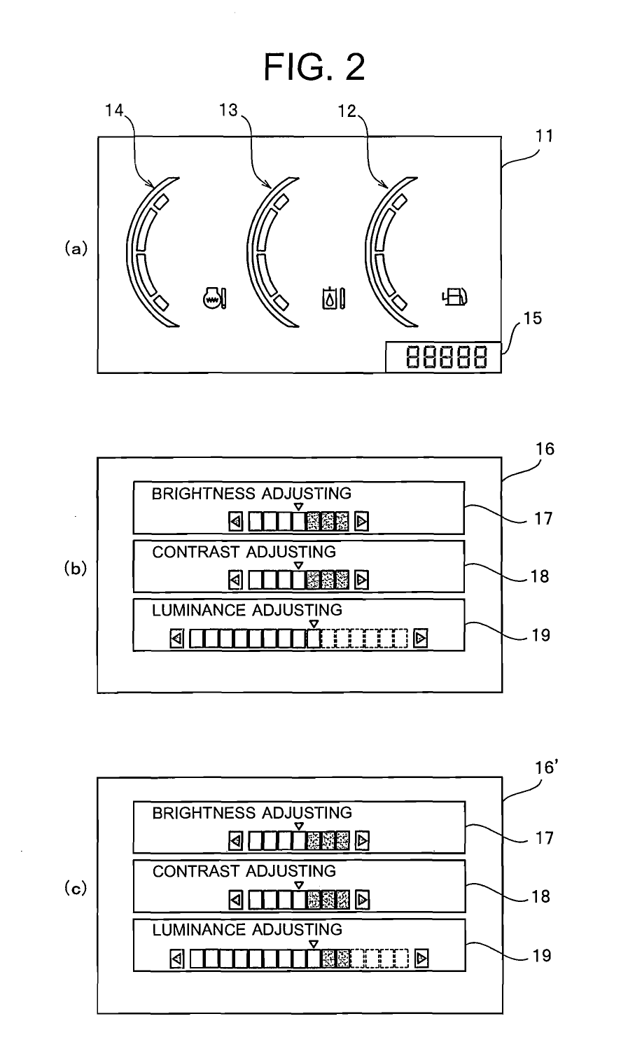

In the first embodiment, the brightness adjusting section 8 and the contrast adjusting section 9 are constituted so that brightness and contrast on the screen can be adjusted in 8 levels from 0 to 7 like an image quality adjusting screen 16 shown in FIG. 2(b) described below, for example. Further, the luminance adjusting section 10 is constituted so that a luminance adjustable range can be changed according to substantial operating time on the backlight 6.

For example, in the case where the luminance adjustable range in the luminance adjusting section 10 is set to the narrowest range, a control range of a voltage to be applied to the backlight is limited to about 50 to 75% of a predetermined voltage, so that the luminance of the backlight can be adjusted in 9 levels from 0 to 8. In the case where the luminance adjustable range is set the most widely, the control range of the voltage applied to the backlight is set to about 50 to 100% of the predetermined voltage, so that the luminance of the backlight can be adjusted in 16 levels from 0 to 15. The predetermined voltage is a voltage applied to the backlight when the backlight is allowed to emit the brightest light at the time of starting the use of the liquid crystal display as described above.

In the monitor section 2, the liquid crystal panel 5 is constituted so that some screens shown in FIGS. 2(a) and 2(b) can be switched to be displayed by an image switching button (not shown). The display screen shown in FIG. 2(a) is a gauge display screen 11 composed of a fuel indicator 12, a water temperature gauge 13 for coolant water of an engine, an oil temperature gauge 14 for hydraulic oil, and a time display section 15 for displaying total operating time of the hydraulic shovel. Normally, when the hydraulic shovel is operated, the gauge display screen 11 is displayed on the liquid crystal panel 5. As a result, the operator can check information such as a residual quantity of fuel, the temperature of coolant water and hydraulic oil, and the operating time of the hydraulic shovel on the screen of the liquid crystal panel 5.

The display screen shown in FIG. 2(b) is an image quality adjusting screen 16 composed of a brightness display section 17, a contrast display section 18 and a luminance display section 19, on which the adjusting state of the image quality set by the image quality adjusting section 7 can be displayed. The image quality adjusting screen 16 can be displayed by the operator's pushing-down of the image switching button during the operation of the hydraulic shovel. The display screen shown in FIG. 2(c) is an image quality adjusting screen 16′ when an upper limit of the luminance adjusting range in the luminance adjusting section is increased more widely than the display screen in FIG. 2(b).

Furthermore, the backlight 6 has a cold cathode fluorescent tube as a light source. The backlight 6 is constituted so that its luminance can be arbitrarily adjusted by adjusting a voltage to be applied to an electrode of the backlight through an operator's manual operation of the luminance adjusting section 10.

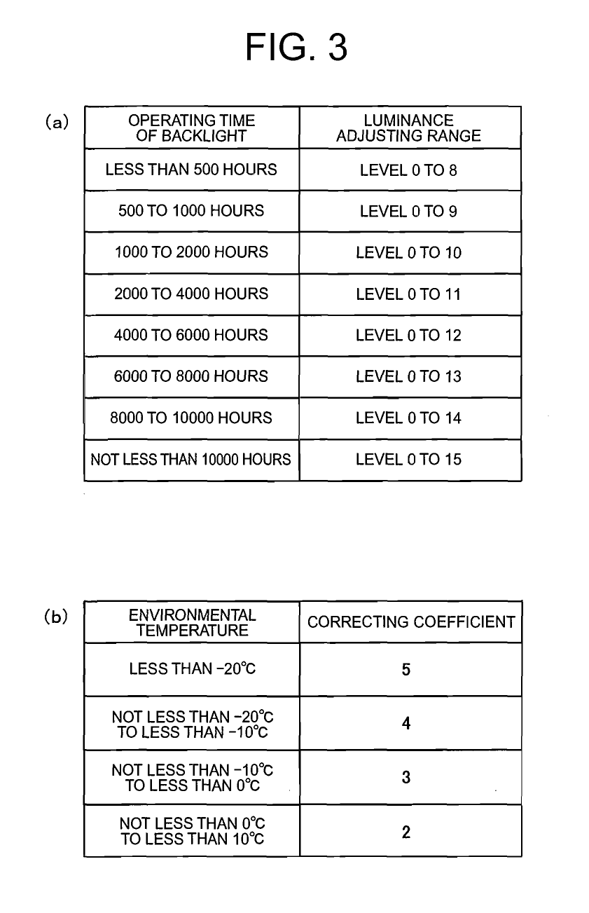

The controller section 3 has setting means 20 and measuring means 21. The setting means 20 has a first storage section 22. In the first storage section 22, the luminance adjusting range is predetermined for each operating time of the backlight 6 so as to be stored, as shown in FIG. 3(a), for example.

The substantial operating time of the backlight 6 becomes an indicator showing a deteriorated state of the luminance in the backlight, and as the substantial operating time becomes longer, aged deterioration of the luminance in the backlight makes progress. Therefore, taking the aged deterioration of the luminance of the backlight into consideration, the luminance adjusting range for each operating time of the backlight 6 stored in the first storage section 22 is predetermined so that as the substantial operating time of the backlight becomes longer, the upper limit of the adjusting range becomes higher. In the first embodiment, as described below, the total operating time of the hydraulic shovel measured by the measuring means 21 is used as the substantial operating time of the backlight to date.

The measuring means 21 has a time counting function, and can measure the total actual operating time from the shipment of the hydraulic shovel to the present date at which it is actually operated. Further, the total operating time to date measured by the measuring means 21 can be read by the setting means 20.

Further, the controller section 3 has a fourth storage section (not shown) which stores a set state of the image quality set in the monitor section 2. As a result, when the operation of the hydraulic shovel is stopped, the controller section 3 can store the set state of the image quality set in the monitor section 2 in the fourth storage section 4 at that time. When the operation of the hydraulic shovel is restarted, the controller section 3 reads the set state of the image quality stored at the previous halt of the operation from the fourth storage section 4, and can set the image quality in the monitor section 2.

The sensor section 4 has a water temperature sensor 25 for coolant water, an oil temperature sensor 26 for hydraulic oil, and a fluid level sensor 27 for a fuel tank. The temperature of the coolant water measured by the water temperature sensor 25 of the sensor section 4 is input into the monitor section 2 via the controller section 3, and is displayed on the water temperature gauge 13 on the gauge display screen 11 of the liquid crystal panel 5.

Similarly, the temperature of the hydraulic oil measured by the oil temperature sensor 26 of the sensor section 4 is displayed on the oil temperature gauge 14 of the gauge displayed screen 11, and a residual quantity of the fuel in the fuel tank measured by the fluid level sensor 27 is displayed on the fuel gauge 12 of the gauge display screen 11.

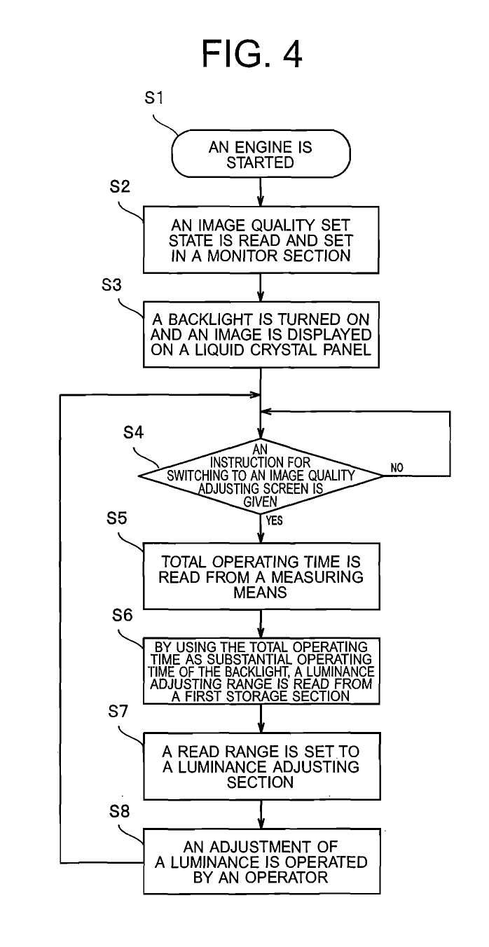

The operation of the liquid crystal display 1 having the above constitution will be described below with reference to the drawings. FIG. 4 is a flow chart illustrating the setting of the luminance adjusting range in the liquid crystal display 1. In the flow chart of FIG. 4, steps 1 to 8 are abbreviated to S1 to S8.

When the engine of the hydraulic shovel is started so that an operation is started (step 1), the controller section 3 reads the image quality set state from the fourth storage section (not shown), and sets the read set state in the monitor section 2 (step 2). At this time, the image quality set state read from the fourth storage section is stored in the fourth storage section by the controller section 3 when the previous operation of the hydraulic shovel is stopped. When the engine is started at step 1, the measuring means 21 of the controller section 3 restarts to measure total actual operating time of the hydraulic shovel to date.

After the image quality is set in the monitor section 2 at step 2, a voltage is applied to the backlight 6 so that the backlight is turned on, and an image is displayed on the liquid crystal panel 5 (step S3). As a result, the gauge display screen 11 shown in FIG. 2(a) is projected on the liquid crystal panel 5, and the operator can check the residual quantity of the fuel.

Thereafter, when the operator pushes down the image switching button (not shown) of the monitor section 2 during the operation of the hydraulic shovel, an instruction for switching the screen of the liquid crystal panel 5 from the gauge display screen 11 to the image quality adjusting screen 16 is given to the liquid crystal display 1 (step 4). When the instruction for switching the screen is given to the liquid crystal display 1, the setting means 20 reads the total operating time of the hydraulic shovel to date measured by the measuring means 21 from the measuring unit 21 of the controller section 3 (step 5).

When the total operating time of the hydraulic shovel is read at step 5, the setting means 20 uses the read total operating time as substantial operating time to present in the backlight 6. Therefore, the setting means 20 can read the luminance adjusting range corresponding to the read total operating time from the first storage section 22 (step 6).

For example, when the measuring means 21 measures the total operating time of the hydraulic shovel to date as about 900 hours and the setting means 20 reads it, the setting means 20 uses “900 hours” as the substantial operating time of the backlight to date. The setting means 20 reads the adjusting range of “level 0 to 9” corresponding to “500 hours to 1000 hours” to which the operating time 900 hours belongs, from the adjusting range for each operating time of the backlight stored in the first storage section 22 shown in FIG. 3(a).

On the other hand, when the measuring means 21 measures the total operating time of the hydraulic shovel as about 4500 hours, the setting means 20 uses “4500 hours” as the substantial operating time of the backlight to date. The adjusting range of “level 0 to 12” corresponding to 4500 hours is read from the first storage section 22. In the first embodiment, the case where the total operating time is 900 hours is described.

After the setting means 20 reads the adjusting range of “level 0 to 9” at step 6, the setting means 20 sets the read range “level 0 to 9” as the luminance adjustable range (step 7) in the luminance adjusting section 10.

Thereafter, the display screen of the liquid crystal panel 5 in the monitor section 2 is switched from the gauge display screen 11 shown in FIG. 2(a) to the image quality adjusting screen 16 shown in FIG. 2(b). At this time, the luminance adjustable range in the luminance adjusting section 10 is set to “level 0 to 9” by the setting means 20. Therefore, the image quality adjusting screen 16 of FIG. 2(b) having the luminance display section 19 where the luminance can be adjusted in 10 levels from 0 to 9 is projected to the liquid crystal panel 5.

Therefore, the operator manually operates the luminance adjusting section 10 of the monitor section 2 so as to enable arbitrary adjustment of the luminance of the backlight 6 in 10 levels from 0 to 9 (step 8).

After the operator adjusts the luminance of the backlight 6 to a desired value, the operator pushes down the image switching button of the monitor section 2 so that the gauge display screen 11 shown in FIG. 2(a) is again displayed on the liquid crystal panel 5. Thereafter, when the operator again pushes down the image switching button of the monitor section 2 and the instruction for switching the screen is given to the liquid crystal display 1, the operation is restarted from step 4. As a result, the setting means 20 can set the suitable luminance adjusting range in the luminance adjusting section 10 every time when the operator adjusts the image quality of the liquid crystal panel 5.

According to the liquid crystal display 1 in the first embodiment, the total operating time of the hydraulic shovel can be used as the substantial operating time to date in the backlight. For this reason, the setting means 20 reads the suitable luminance adjusting range from the total operating time of the hydraulic shovel based on the luminance adjusting range predetermined for each operating time of the backlight, and can set the read range as the luminance adjusting range in the luminance adjusting section 10.

Therefore, when the operator adjusts the luminance of the backlight, the operator can arbitrarily adjust the luminance of the backlight 6 through the manual operation within the adjusting range set by the setting means 20. Particularly, the setting means 20 can set the upper limit of the luminance adjusting range to a suitable value according to the total operating time of the hydraulic shovel. For this reason, the operator can be prevented from setting excessively high luminance of the backlight 6, thereby prolonging the lifetime of the backlight.

As the total operating time of the hydraulic shovel becomes longer, the setting means 20 can increase the upper limit of the adjusting range set in the luminance adjusting section 10. As a result, even if aged deterioration in the backlight 6 occurs as the total operating time becomes longer, the operator can adjust the voltage so that a higher voltage can be applied to the backlight. Therefore, it is possible to prevent the deterioration in the contrast and the image quality due to the aged deterioration in the backlight which is conventionally a problem.

### SECOND EMBODIMENT

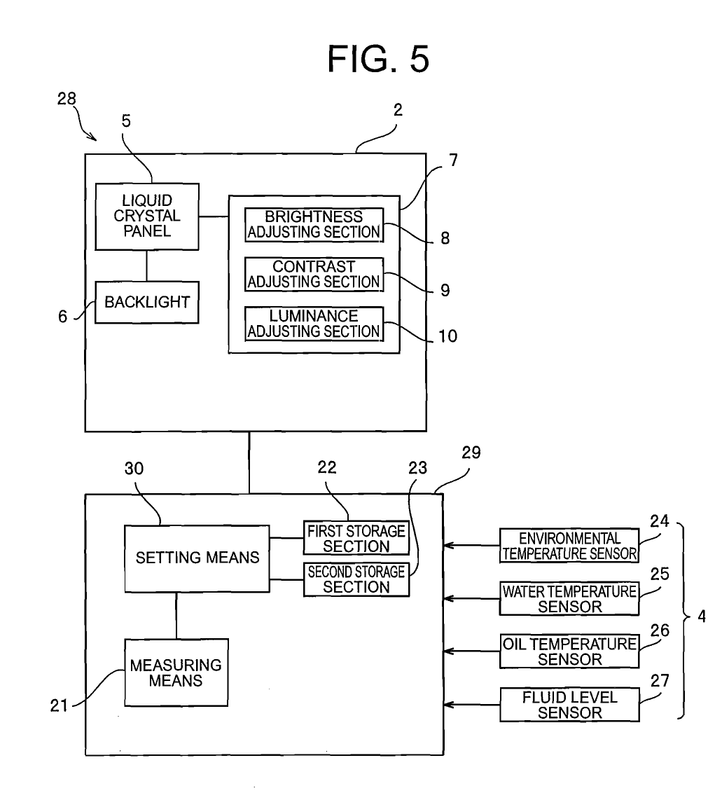

A liquid crystal display according to a second embodiment of the present invention will be described below. FIG. 5 is a block diagram illustrating a constitution of the liquid crystal display according to the second embodiment. In the following description and the drawings to be referred in the example, members having the similar constitutions to those described in the first embodiment are denoted by the similar reference numerals, and the description thereof is omitted.

A liquid crystal display 28 according to the second embodiment shown in FIG. 5 is composed of a monitor section 2, a controller section 29 which controls the monitor section 2, and a sensor section 4.

The controller section 29 has setting means 30 and measuring means 21. The setting means 30 has first and second storage sections 22 and 23. Similarly to the first embodiment, the first storage section 22 has the luminance adjustable range for each operating time of the backlight, as shown in FIG. 3(a), predetermined therein in advance.

As shown in FIG. 3(b), correcting coefficients for each predetermined environmental temperature are stored in the second storage section 23 of the setting means 30. Taking the temperature dependence on the luminance in the backlight into consideration, the correcting coefficients for each environmental temperature stored in the second storage section 23 are predetermined so that as the environmental temperature of the liquid crystal display 28 becomes lower, the upper limit of the luminance adjusting range can be set to a larger value.

As a result, when the environmental temperature at which the liquid crystal display 28 is used is low, a luminance adjustable range in a luminance adjusting section 10 can be increased. For this reason, when the operator manually operates the luminance adjusting section 10, the voltage can be adjusted so that a higher voltage can be applied to the backlight.

The controller section 29 in the second embodiment has a fourth storage section (not shown) which stores a set state of an image quality set by the monitor section 2 similarly to the first embodiment.

The sensor section 4 further has a water temperature sensor 25, an oil temperature sensor 26, a fluid level sensor 27, and an environmental temperature sensor 24 as temperature measuring means. The environmental temperature sensor 24 is constituted so as to measure environmental temperature at which the liquid crystal display 28 is used, and allow the setting means 30 of the controller section 29 to read the measured environment temperature.

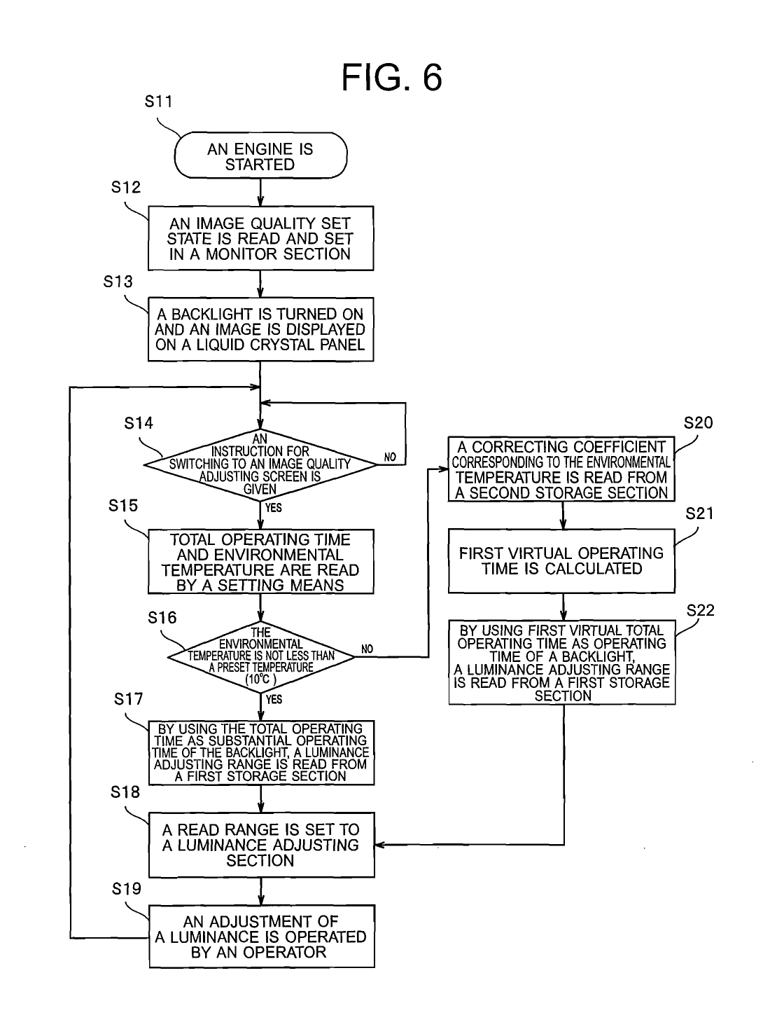

The operation of the liquid crystal display 28 having the above operation will be described below with reference to the drawings. FIG. 6 is a flow chart illustrating the setting of the luminance adjusting range in the liquid crystal display 28.

When the engine of the hydraulic shovel is started (step 11), the controller section 29 reads the image quality set state from the fourth storage section (not shown), and sets the read set state in the monitor section 2 (step 12). When the engine is started at step 11, the measuring means 21 of the controller section 29 restarts to measure the total operating time of the hydraulic shovel. At the same time, the environmental temperature sensor 24 of the sensor section 4 measures the environmental temperature at which the liquid crystal display 28 is used.

After the image quality is set in the monitor section 2 at step 12, a voltage is applied to the backlight 6 so that the backlight is turned on, and an image is displayed on the liquid crystal panel 5 (step 13). As a result, the gauge display screen 11 shown in FIG. 2(a) is projected to the liquid crystal panel 5.

Thereafter, the operator pushes down the image switching button of the monitor section 2 during the operation of the hydraulic shovel, so that an instruction for switching the screen of the liquid crystal panel 5 from the gauge display screen 11 to the image quality adjusting screen 16 is given to the liquid crystal display 28 (step 14). When the operator gives the instruction for switching the screen, the setting means 30 of the controller section 29 reads the total operating time of the hydraulic shovel to date from the measuring means 21, and reads the current environmental temperature from the environmental temperature sensor 24 (step 15).

After the total operating time to date and the current environmental temperature are read at step 15, the setting means 30 determines whether the read environmental temperature is not less than or less than a preset certain temperature (step 16). In the second embodiment, the setting means 30 determines whether the environmental temperature is not less than 10° C. or less than 10° C., for example. When the environmental temperature is not less than 10° C., the operation from step 17 described below is performed. When the environmental temperature is less than 10° C., on the other hand, the operation from step 20 is performed.

The case where the environmental temperature of the liquid crystal display 28 is not less than 10° C. is described first. When the setting means 30 determines that the environmental temperature is not less than 10° C. at step 16, the setting means 30 uses the total operating time of the hydraulic shovel to date read from the measuring means 21 as the operating time of the backlight similarly to the first embodiment so as to read the luminance adjusting range corresponding to the total operating time from the first storage section 22 (step 17). That is, when the total operating time of the hydraulic shovel is about 900 hours, the setting means 30 uses “900 hours” as the operating time of the backlight, so as to read the corresponding adjusting range in “level 0 to 9” from the first storage section 22.

After the adjusting range in “level 0 to 9” is read at step 17, the setting means 30 sets the read adjusting range in “level 0 to 9” as the luminance adjustable range in the luminance adjusting section 10 (step 18).

Thereafter, the display screen of the liquid crystal panel 5 in the monitor section 2 is switched to the image quality adjusting screen 16 shown in FIG. 2(b). The operator manually operates the luminance adjusting section 10 of the monitor section 2 so as to enable arbitrary adjustment of the luminance of the backlight 6 in 10 levels from 0 to 9 (step 19).

On the other hand, an explanation will be given of the case where the current environmental temperature measured by the environmental temperature sensor 24 is, for example, −15° C. and the setting means 30 determines that the environmental temperature is less than 10° C. as the certain temperature at step 16.

In this case, the setting means 30 reads the correcting coefficient corresponding to the environmental temperature of −15° C. from the second storage section 23 (step 20). That is, the setting means 30 reads the correcting coefficient “4” corresponding to the environmental temperature “not less than −20° C. to less than −10° C.” from the correcting coefficients for each environmental temperature stored in the second storage section 23 shown in FIG. 3(b).

The setting means 30 multiplies the total operating time “900 hours” to date read from the measuring means 21 by the read correcting coefficient “4” so as to calculate “3600 hours” to be first virtual total operating time (step 21).

The setting means 30 uses the calculated first virtual total operating time “3600 hours” as the substantial operating time to date in the backlight, so as to read the luminance adjusting range corresponding to the first virtual total operating time “3600 hours” from the first storage section 22 (step 22). That is, the setting means 30 reads the adjusting range “level 0 to 11” corresponding to “2000 hours to 4000 hours” to which “3600 hours” belongs, from the first storage section 22 shown in FIG. 3(a).

After the setting means 30 reads the luminance adjustable range in “level 0 to 11”, the setting means 30 sets the read adjusting range in “level 0 to 11” as the luminance adjustable range in the luminance adjusting section 10 (step 18).

Thereafter, when the display screen on the liquid crystal panel 5 is switched to the image quality adjusting screen, the image quality adjusting screen 16′ in FIG. 2(c) where the luminance of the backlight 6 can be adjusted in 12 levels from 0 to 11 is projected to the liquid crystal panel 5. As a result, the operator manually operates the luminance adjusting section 10 so as to enable arbitrary adjustment of the luminance of the backlight 6 within the range of level 0 to 11.

According to the liquid crystal display 28 in the second embodiment, the setting means 30 can suitably set the luminance adjustable range in the luminance adjusting section 10 based on the total operating time of the hydraulic shovel to date and the environmental temperature of the liquid crystal display 28. As a result, the operator can arbitrarily adjust the luminance of the backlight 6 through a manual operation within the set adjusting range. In the second embodiment, similarly to the first embodiment, the operator is prevented from setting the excessively high luminance of the backlight 6, thereby prolonging the lifetime of the backlight. It is also possible to prevent the deterioration in the contrast and the image quality due to the aged deterioration in the backlight.

In the second embodiment, the luminance adjusting range in the luminance adjusting section 10 is suitably set according to the environmental temperature at which the liquid crystal display 28 is used. This makes it possible to prevent the deterioration in the image quality due to the temperature dependence on the luminance in the backlight 6.

In the description in the second embodiment and the flow chart of FIG. 6, the environmental temperature to be the standard is, for example, 10° C., but the present invention is not limited to this, and thus the environmental temperature can be suitably changed according to environments where the liquid crystal display is used.

### THIRD EMBODIMENT

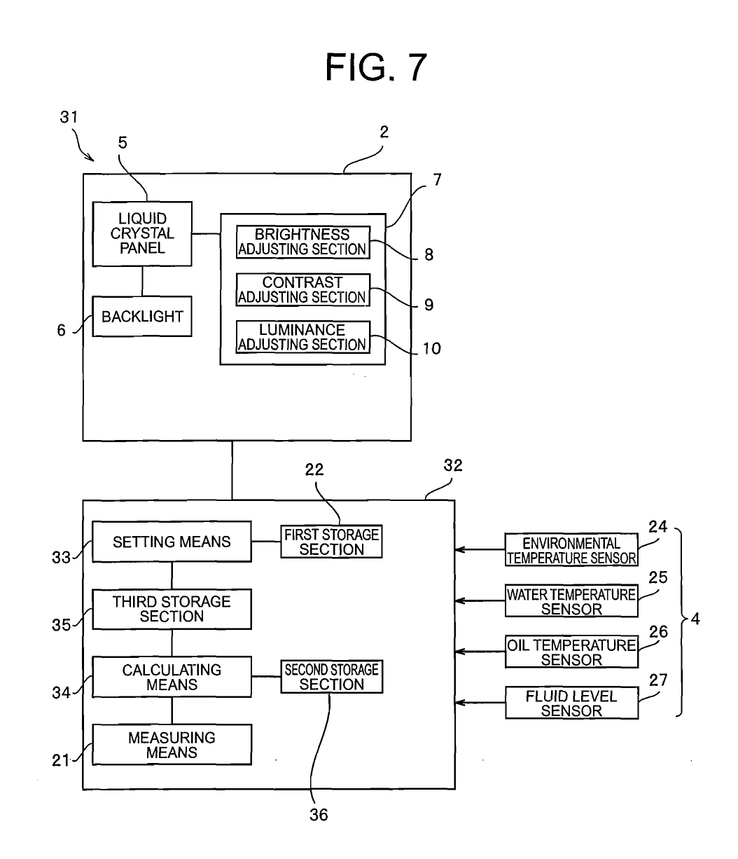

A liquid crystal display according to a third embodiment of the present invention will be described below. FIG. 7 is a block diagram illustrating a constitution of the liquid crystal display according to the third embodiment.

The liquid crystal display 31 of the third embodiment shown in FIG. 7 is composed of a monitor section 2, a controller section 32 which controls the monitor section 2, and a sensor section 4. The controller section 32 has setting means 33, calculating means 34, measuring means 21 and a third storage section 35.

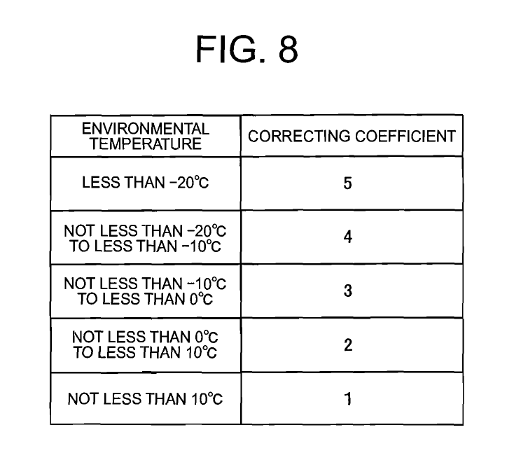

In the controller section 32, the setting means 33 has a first storage section 22 similar to that of the first embodiment shown in FIG. 3(a). The calculating means 34 has a second storage section 36. The second storage section 36 stores correcting coefficients for each predetermined environmental temperature therein as shown in FIG. 8. Besides the correcting coefficients predetermined in the second storage section 23 (see FIG. 3(b) described in the second embodiment, correcting coefficient “1” corresponding to the environmental temperature “not less than 10° C.” is predetermined.

The calculating means 34 is constituted so as to successively read the total operating time of the hydraulic shovel to date from the measuring means 21. The environmental temperature of the liquid crystal display 31 is read from the environmental temperature sensor 24 every predetermined time (for example, every 1 minute). Further, the calculating means 34 is designed to calculate an average value of the environmental temperatures read from the environmental temperature sensor 24 every time when the total operating time read from the measuring means 21 after the starting the operation of the work vehicle exceeds unit operating time based on the total operating time and the environmental temperature read from the measuring means 21 and the environmental temperature sensor 24.

As a result, the calculating means 34 can calculate corrected operating time obtained by correcting elapsed unit operating time every time when the total operating time read from the measuring means 21 after the starting of the operation of the hydraulic shovel exceeds the unit operating time as detailed below.

The third storage section 35 sequentially adds the corrected operating time calculated by the calculating means 34 and stores the added time therein, so as to store second virtual total operating time. The controller section 32 in the third embodiment has a fourth storage section (not shown) which stores the set state of the image quality set in the monitor section similarly to the first and second embodiments.

In the third embodiment, the case where the value of the unit operating time is set to “1 hour” is described, but the present invention is not limited to this, and the value of the unit operating time can be arbitrarily set. In the present invention, the calculating means 34 may calculate a minimum value of the environmental temperatures read from the environmental temperature sensor 24 in the unit operating time instead of the average value of the environmental temperatures in the unit operating time.

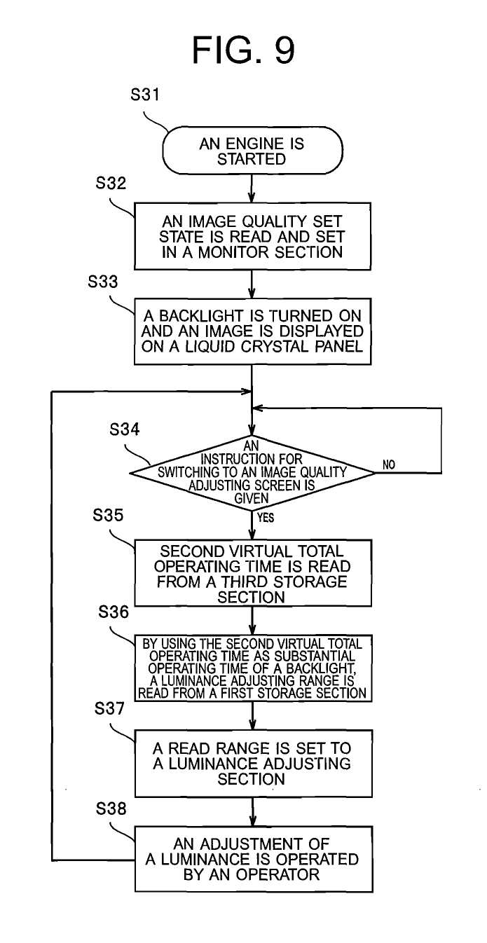

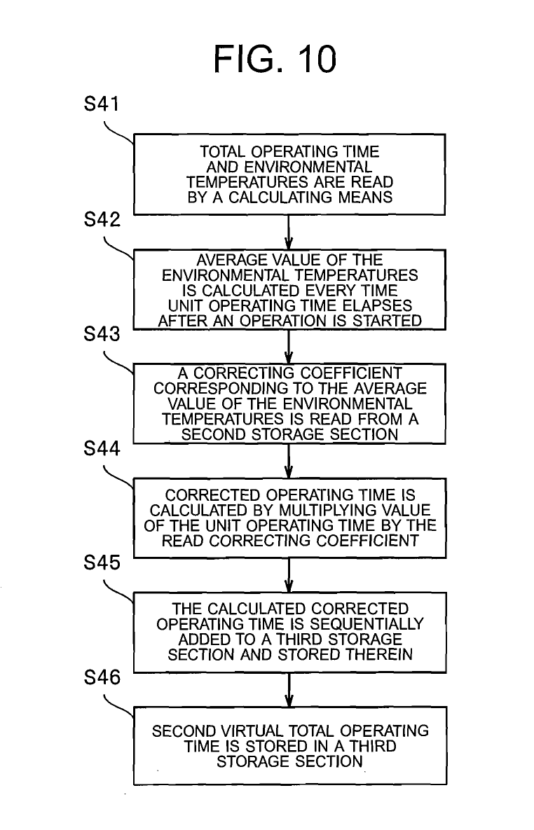

The operation of the liquid crystal display 31 in the third embodiment will be described below with reference to the drawings. FIG. 9 is a flow chart illustrating the setting of a luminance adjusting range in the liquid crystal display 31. FIG. 10 is a flow chart illustrating calculation of second virtual total operating time.

When the engine of the hydraulic shovel is started (step 31), the controller section 32 reads the image quality set state from the fourth storage section 4 (not shown), and sets the read set state in the monitor section 2 (step 32). When the engine is started at step 31, the measuring means 21 restarts to measure the total operating time of the hydraulic shovel, and the environmental temperature sensor 24 measures the environmental temperature of the liquid crystal display 31.

After the image quality is set at step 32, a voltage is applied to the backlight 6 to turn on the backlight 6 and display an image on the liquid crystal panel (step 33). As a consequence, the gauge display screen 11 shown in FIG. 2(a) is projected to the liquid crystal panel 5.

Thereafter, the operator pushes down the image switching button of the monitor section 2 during the operation of the hydraulic shovel, so that the instruction for switching the screen of the liquid crystal panel 5 from the gauge display screen 11 to the image quality adjusting screen 16 is given to the liquid crystal display 31 (step 34). When the screen switching instruction is given to the liquid crystal display 31, the setting means 33 of the controller section 32 reads second virtual total operating time from the third storage section 35 (step 35). At this time, the third storage section 35 has stored therein the second virtual total operating time calculated at steps 41 to described below.

The calculation of the second virtual total operating time will be described with reference to FIG. 10. When the engine is started at step 31, the calculating means 34 successively reads the total operating time to date of the hydraulic shovel from the measuring means 21, and reads environmental temperatures every predetermined time, for example, 1 minute from the environmental temperature sensor 24 (step 41).

The calculating means 34 calculates an average value of the environmental temperatures read from the environmental temperature sensor 24 every 1 hour set as unit operating time in the total operating time of the hydraulic shovel read from the measuring means 21 after the operation of the hydraulic shovel is started (the engine is started) (step 42).

After the average value of the environmental temperatures at the unit operating time is calculated, the calculating means 34 reads the correcting coefficient corresponding to the average value of the calculated environmental temperatures from the second storage section 36 (step 43). For example, when the average value of the environmental temperatures at the unit operating time is calculated as about −5° C., for example, the correcting coefficient “3” is read from the second storage section 36.

The calculating means 34 multiplies “1 hour” set as the unit operating time by the read correcting coefficient “3”. As a result, “3 hours” can be calculated as the corrected operating time obtained by correcting the actually elapsed unit operating time (step 44). When the average value of the environmental temperatures at the unit operating time is about 20° C., for example, the correcting coefficient “1” is read from the second storage section 36, and thus “1 hour” is calculated as the corrected operating time.

After the corrected operating time is calculated at step 44, the calculating means 34 adds the corrected operating time “3 hours” to the total value of the corrected operating time stored in the third storage section 35, namely, the total value of the corrected operating time calculated by the calculating means 34 so as to store the added value (step 45).

That is, in the third embodiment, every time when the total operating time of the hydraulic shovel exceeds the unit operating time after the operation of the hydraulic shovel is started, the calculating means 34 calculates the corrected operating time. Every time when the calculating means 34 calculates the corrected operating time, the third storage section 35 can sequentially add the corrected operating time calculated by the calculating means 34 so as to store the added value therein. Consequently, the third storage section can update to store the second virtual total operating time to date from the shipment of the hydraulic shovel every time when the corrected operating time is calculated by the calculating means 34 (step 46).

In the third embodiment, in order to obtain the second virtual total operating time of the hydraulic shovel more accurately, the calculating means 34 can calculate the corrected operating time even at the time of stopping the operation of the hydraulic shovel. Further, the calculated corrected operating time can be added to and stored in the third storage section 35.

That is, when the operation of the hydraulic shovel is stopped, the calculating means 34 calculates previous corrected operating time, and calculates operating time up to the operation of the hydraulic shovel is stopped (herein after, this operating time is called as the operating time before stopping) based on the total operating time of the hydraulic shovel read from the measuring means 21. The calculating means 34 corrects the calculated operating time before stopping so as to calculate the corrected operating time.

More specifically, in the case where the time from the calculation of the previous corrected operating time to the stopping of the operation of the hydraulic shovel is, for example, 30 minutes, the calculating means 34 calculates “0.5 hour” as the operating time before stopping. Then, the calculating means 34 calculates the average value of the environmental temperatures read from the environmental temperature sensor 24 for “0.5 hour”.

Further, the correcting coefficient corresponding to the calculated average value of the environmental temperatures is read from the second storage section 36, and the operating time before stopping “0.5 hour” is multiplied by the read correcting coefficient. In this manner, the corrected operating time obtained by correcting the operating time before stopping can be calculated. The calculated corrected operating time is added and stored in the third storage section 35, so that the second virtual total operating time at the operation stopping time of the hydraulic shovel can be stored in the third storage section 35.

As a result, even if the operation of the hydraulic shovel is stopped during the unit operating time, an error can be prevented from occurring in the second virtual total operating time. Therefore, the second virtual total operating time stored in the third storage section can be suitably used as the substantial operating time to date in the backlight as described below. For example, even in the case where a temperature difference is present between the environmental temperature at the time of stopping the operation of the hydraulic shovel and the environmental temperature at the time of restarting the operation, the corrected operating time can be calculated based on the respective environmental temperatures, resulting in accurate determination of the second virtual total operating time.

The second virtual total operating time stored in the third storage section 35 can be read by the setting means 33 at step 35 shown in FIG. 9.

After the setting means 33 reads the second virtual total operating time at step 35, the read second virtual total operating time is used as the substantial operating time to date in the backlight, so that the luminance adjusting range corresponding to the second virtual total operating time is read from the first storage section 22 (step 36). The setting means 33 sets the adjusting range read from the first storage section 22 as a luminance adjustable range in the luminance adjusting section 10 (step 37).

Thereafter, the display screen of the liquid crystal panel 5 is switched to the image quality adjusting screen. As a result, the operator manually operates the luminance adjusting section 10 so as to enable arbitrary adjustment of the luminance of the backlight 6 within the adjusting range set by the setting means at step 37 (step 38).

In the third embodiment, the luminance adjusting range in the luminance adjusting section 10 can be set very suitably based on the second virtual total operating time corresponding to a change in the environmental temperature at each unit operating time. As a result, the operator can arbitrarily and manually adjust the luminance of the backlight 6 within the set adjusting range. Further, the operator can be prevented from setting the excessively high luminance of the backlight, and the lifetime of the backlight can be prolonged. It is also possible to prevent the deterioration in the contrast and the image quality due to the aged deterioration in the backlight.

In the third embodiment, the calculating means 34 calculates the average value of the environmental temperatures at each unit operating time, so as to obtain the second virtual total operating time. In the present invention, however, the calculating means 34 may calculate a minimum value of the environmental temperatures at each unit operating time instead of the average value of the environmental temperatures so as to obtain the second virtual total operating time using the minimum value of the environmental temperatures.

### INDUSTRIAL APPLICABILITY

The liquid crystal display of the present invention can be suitably applied to work vehicles such as a construction machine and an automobile including a hydraulic shovel.

1: A liquid crystal display to be installed in a work vehicle, comprising:
a luminance adjusting section which can manually adjust luminance of a backlight in a liquid crystal panel;
setting means for setting a luminance adjustable range by means of the luminance adjusting section; and
measuring means for measuring total operating time to date for which the work vehicle actually operates,
the setting mean includes a first storage section which stores a predetermined luminance adjusting range for each operating time of the backlight, and
the setting means uses the total operating time measured by the measuring means as substantial operating time so as to read a luminance adjusting range corresponding to the operating time from the first storage section, and sets the read adjusting range as the luminance adjustable range in the luminance adjusting section.

2: The liquid crystal display according to claim 1, comprising:
temperature measuring means for measuring environmental temperature in which the liquid crystal display is to be used,
wherein the setting means:
includes a second storage section which stores predetermined correcting coefficients for each environmental temperature therein, and reads the total operating time measured by the measuring means and the environmental temperature measured by the temperature measuring means;
reads the correcting coefficient corresponding to the read environmental temperature from the second storage section;
multiplies the read total operation time by the read correcting coefficient so as to calculate first virtual total operating time; and
uses the calculated first virtual total operating time as the substantial operating time to date in the backlight.

3: The liquid crystal display according to claim 2, wherein the setting means determines whether or not the environmental temperature read from the temperature measuring means is less than predetermined temperature, and when the read environmental temperature is not less than the predetermined temperature, the setting means does not calculate the first virtual total operating time and uses the total operating time measured by the measuring means as the substantial operating time to date in the backlight, and when the read environmental temperature is less than the predetermined temperature, the setting means calculates the first virtual total operating time based on the environmental temperature, and uses the calculated first virtual total operating time as the substantial operating time to date in the backlight.

4: The liquid crystal display according to claim 1, comprising:
temperature measuring means for measuring environmental temperature in which the liquid crystal display is to be used;
calculating means for calculating corrected operating time obtained by correcting elapsed unit operating time based on the environmental temperature read from the temperature measuring means every time when the total operating time read from the measuring means exceeds the unit operating time after a starting of an operation of the work vehicle; and
a third storage section which sequentially adds and stores the corrected operating time calculated by the calculating means so as to store second virtual total operating time,
wherein the calculating means:
includes a second storage section which stores predetermined correcting coefficients for each of the environmental temperature therein, and calculates an average value or a minimum value of the environmental temperatures read from the temperature measuring means within the unit operating time every time when the total operating time read from the measuring means exceeds the unit operating time after a staring of an operation of the work vehicle;
reads a correcting coefficient corresponding to the calculated average value or the minimum value of the environmental temperatures from the second storage section;
multiplies a value of the unit operating time by the read correcting coefficient so as to calculate corrected operating time by correcting the unit operating time; and
sequentially adds and stores the calculated corrected operating time in the third storage section every time when the corrected operating time is calculated so as to store second virtual total operating time in the third storage section, and
the setting means:
reads the second virtual total operating time from the third storage section; and
uses the read second virtual total operating time as the substantial operating time to date in the backlight.
